(19) United States
(12) Patent Application Publication
(10) Pub. No.: US 2012/0110004 A1
(43) Pub. Date: May 3, 2012

(54) HOMOMORPHISM LEMMA FOR EFFICIENTLY QUERYING DATABASES

(75) Inventor: Henricus Johannes Maria Meijer, Mercer Island, WA (US)

(73) Assignee: MICROSOFT CORPORATION, Redmond, WA (US)

(21) Appl. No.: 12/939,146

(22) Filed: Nov. 3, 2010

(51) Int. Cl. G06F 17/30

(52) U.S. Cl. 707/769; 707/E17.014

(57) ABSTRACT

A representation of a language-integrated query can be generated based upon a homomorphism characteristic of the query. The representation can be utilized to enable efficient execution of the query on a key-value store, for example. More specifically, the query can be transformed into a representation utilizing language integrated query operators that enables parallel execution.

### BACKGROUND

A data model describes how data can be stored and accessed. More formally, data models define data entities and relationships between the data entities. The primary objective of a data model is to provide a definition and format of data to facilitate management and processing of vast quantities of data. One application of data models is database models, which define how a database or other store is structured and utilized. A database model can be relational or non-relational.

In a relational model, or more particularly a relational database, data is structured in terms of one or more tables. Tables are relations that comprise a number of columns and rows, wherein the named columns are referred to as attributes and rows capture data for specific entity instances. For example, a table can capture information about a particular entity such as a book in rows, also called tuples, and columns. The columns identify various attributes of an entity such as the title, author, and year of publication of a book. The rows capture an instance of an entity such as a particular book. In other words, each row in the table represents attributes of a particular book. Further yet, a table can include primary and foreign keys that enable two or more tables to be linked together.

Amongst many implementations a non-relational model, a key-value model is one of the most popular. Key-value databases or stores represent a simple data model that maps unique keys to a set of one or more values. More specifically, the key-value store stores values and an index to facilitate location of the stored values based on a key. For example, a key be located that identifies one of a title, author, or publication of a data of a book.

Relational databases are often referred to as SQL databases while some non-relational databases are called NoSQL databases or stores. SQL stands for Structured Query Language, which is the primary language utilized to query and update data in a relational database. When SQL is utilized in conjunction with a relational database, the database can be referred to as a SQL-based relational database. However, more often a SQL-based relational database is simply referred to as a SQL database and used as a synonym for a relational database. NoSQL is a term utilized to designate databases that differ from SQL-based relational databases. In other words, the term NoSQL is used as a synonym for a non-relational database or store such as but not limited to a key-value store.

SQL databases and NoSQL stores have a number of advantages and disadvantages that are captured at a high level by the CAP theorem, which states that of consistency (C), availability (A), and partition tolerance (P) only two can be guaranteed at any one time. Consistency refers to a characteristic of a system to remain in a consistent state after an operation such as an update. Availability concerns remaining operational over a period of time, even with the presence of failures, and partition tolerance refers to the ability of a system to operate across network partitions. Typically, the design choice for SQL databases is to choose consistency and availability over partition tolerance, and for NoSQL stores to drop consistency in favor or partition tolerance and availability. In other words, NoSQL stores sacrifice consistency for scalability or alternatively SQL databases sacrifice scalability for consistency.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to employing a homomorphism lemma for efficient querying of databases. A representation of a language-integrated query (LINQ) can be created that is based upon a homomorphism characteristic of the query such as Bird's Homomorphism Lemma Such a representation of the LINQ query can be subsequently utilized to execute the query over a database such as but not limited to a key-value store. By way of example and not limitation, the LINQ query can be transformed into a representation with the employment of a first LINQ operator and a second LINQ operator in which the first LINQ operator is at least one of a “Select,” a “SelectMany,” or a “GroupBy” and the second LINQ operator is at least one of a “Reduce” or an “Aggregate.”

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a database querying system.

FIG. 2 is a block diagram of database querying systems.

FIG. 3 depicts an exemplary collection of a key-value store.

FIG. 4 is a block diagram of a database querying system for relational stores and key-value stores.

FIG. 5 is a block diagram of a system that facilitates generating a representation of a language-integrated query (LINQ) query.

FIG. 6 is a flow chart diagram of a method of transforming a LINQ query into a representation.

FIG. 7 is a flow chart diagram of a method creating a representation of a LINQ query.

FIG. 8 is a flow chart diagram of a method querying a relational store and a key-value store with a LINQ query.

FIG. 9 is a schematic block diagram illustrating a suitable operating environment for aspects of the subject disclosure.

### DETAILED DESCRIPTION

Details below are generally directed toward database querying. A representation of a query such as a language-integrated query (LINQ or LINQ query) can be generated based upon a homomorphism characteristic of the query. The representation of the LINQ query can be utilized to execute the LINQ query efficiently on a database such as a key-value store. Conventionally, LINQ queries have been employed with respect to relational databases (e.g., SQL). However, LINQ queries can be extended to operate with respect non-relational stores (e.g., NoSQL, key-value store). Moreover, a representation of the LINQ query can be generated that is utilized to execute such query efficiently over a relational and/or non-relational store, for example utilizing parallel processing or more specifically distributed parallel processing.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

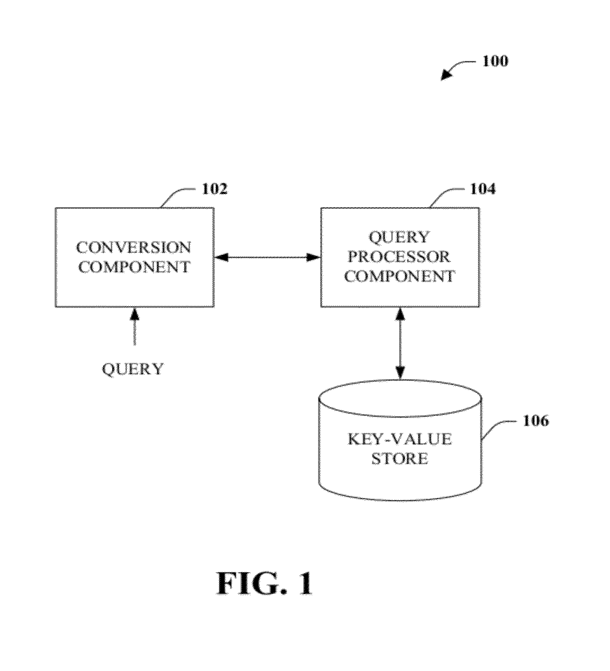

Referring initially to FIG. 1, a database querying system 100 is illustrated. The database querying system 100 utilizes a representation of a query such as a language integrated query (LINQ or LINQ query) in order to efficiently execute the query on a key-value store, among others.

LINQ, and supporting technology, provide a convenient and declarative shorthand query syntax (e.g., SQL-like) to facilitate specification of queries within a programming language (e.g., C#®, Visual Basic® . . . ). More specifically, query operators are provided that map to lower-level language constructs or primitives such as methods and lambda expressions. Query operators are provided for various families of operations (e.g., filtering, projection, joining, grouping, ordering . . . ), and can include but are not limited to “where” and “select” operators that map to methods that implement the operators that these names represent. By way of example, a user can specify a query in a form such as “from n in numbers where n<10 select n,” wherein “numbers” is a data source and the query returns integers from the data source that are less than ten. Further, query operators can be combined in various ways to generate queries of arbitrary complexity.

Conventionally, LINQ queries have be specified and executed with respect to a relational store. However, LINQ queries can be extended to support execution over non-relational data such as key-value stores. More specifically, by utilizing the homomorphism characteristic of the LINQ query, a representation of such LINQ query can be generated and utilized to execute the LINQ query on a key-value store. Stated differently, a representation of the LINQ query is created based upon Bird's First Homomorphism Lemma, wherein such representation allows execution of the LINQ query on a key-value store.

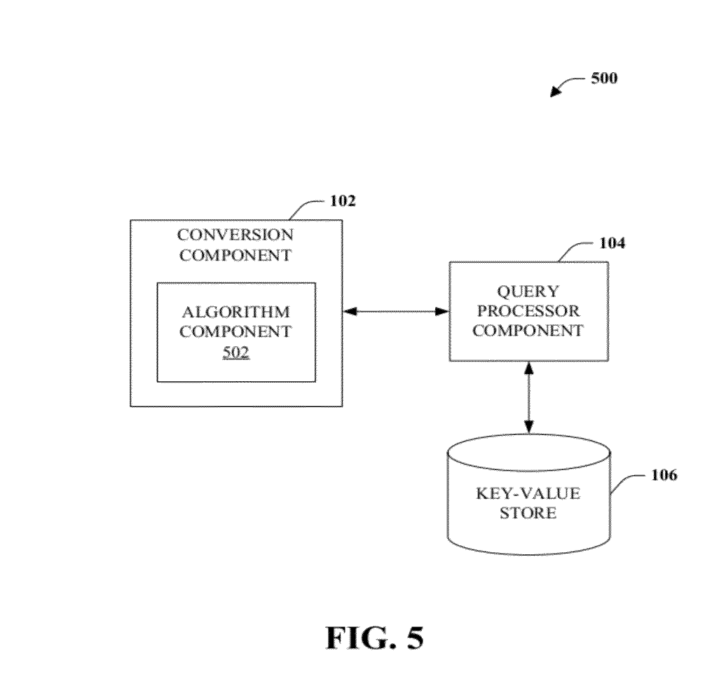

The database querying system 100 includes a conversion component 102 that generates a representation of a LINQ query based upon a homomorphism characteristic of such LINQ query. The conversion component 102 transforms the LINQ query into a representation by implementing functions, algorithms, and/or operators (discussed in more detail below, in particular FIG. 5). Such representation of the LINQ query enables extended capabilities in regards to a key-value store 106. A query processor component 104 utilizes the representation of the LINQ query in order to execute such LINQ query on a key-value store 106. It is to be appreciated that the key-value store 106 can be, but is not limited to, any suitable non-relational store and/or NoSQL store. For example, in one embodiment, the key-value store can correspond to a mathematical dual of a relational store (e.g., coSQL).

By way of example and not limitation, a homomorphism characteristic is a structure-preserving map between two algebraic structures (such as groups, collections, sets, etc.). Additionally, a homomorphism is a function between two algebraic objects (e.g., groups, collections, sets, etc.) that respects the algebraic structure. In general, a query that includes a homomorphism characteristic will maintain such property of homomorphism, or, in other words, remain homomorphic. Furthermore, it is to be appreciated that queries can be homomorphisms, because the queries are created from homomorphic parts. In other words, homomorphism characteristics are enforced in order to generate representations that enable querying on various databases, stores, etc.

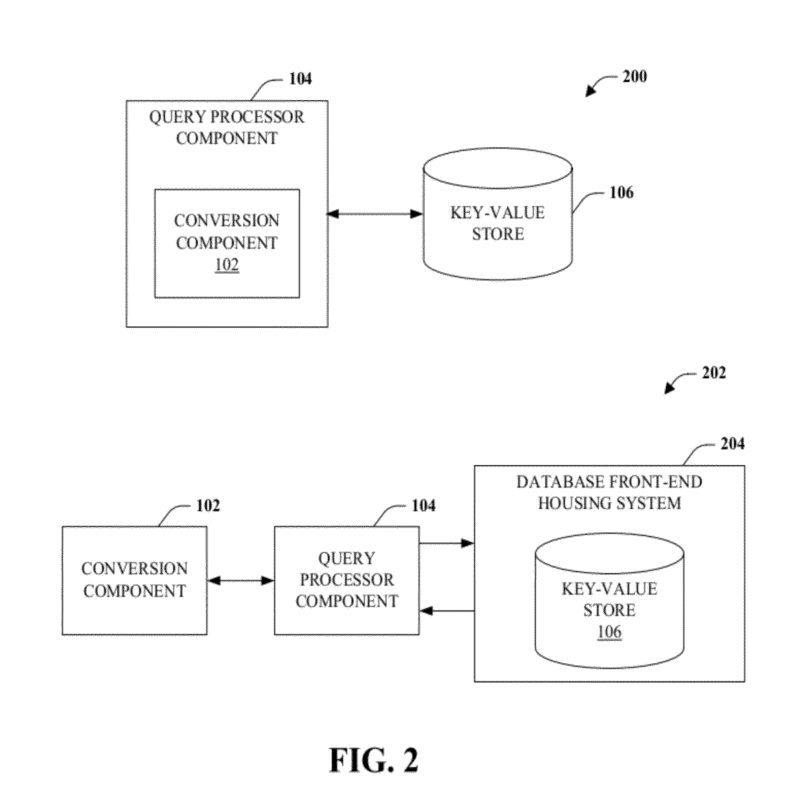

FIG. 2 illustrates exemplary database querying system embodiments. A querying system 200 includes the conversion component 102 that generates a representation of the LINQ query. As discussed, the conversion component 102 transforms the LINQ query into a representation based upon a homomorphism characteristic for extended versatility, among other things, in regards to databases. The querying system 200 also includes the query processor 104 that executes the representation on the key-value store 106 directly. In other words, the conversion component 102 can generate the representation of the LINQ query and the query processor 104 directly executes the representation, and in turn the LINQ query, on the key-value store 106.

The querying system 200 depicts the conversion component 102 incorporated into the query processor component 104 by way of example and not by limitation. It is to be appreciated that the conversion component 102 can be a stand-alone component, incorporated into the query processor component 104, incorporated into the key-value store 106, and/or any combination thereof.

FIG. 2 further illustrates a querying system 202 that includes the conversion component 102 coupled to the query processor component 104. The querying system 202 enables the representation to be communicated to a database front-end housing system 204 in order to be executed on the key-value store 106. The database front-end housing system 204 can be any suitable front-end system associated with the key-value store 106 that manages access. The database front-end housing system 204 can further include various security and authentication techniques in order to ensure data privacy and integrity, amongst other functionality associated with database systems.

In particular, the database front-end housing system 204 can manage incoming query requests on the key-value store 106. Thus, the query processor component 104 can provide the representation of the LINQ query to the database front-end housing system 204 in which the database front-end housing system 204 utilizes the representation to execute the LINQ query on the key-value store 106. For example, the database front-end housing system 204 can include an internal query processor (not shown) that performs queries and returns results. Such internal query processor (not shown) can utilize the representation of the LINQ query to execute such query on the key-value store 106. In another example but not in limitation, the query processor component 104 can utilize a combination of directly executing the representation on the key-value store 106 and communicating at least a portion of the representation to the database front-end housing system 204 to execute internally (e.g., internal query processor). In such a situation the query processor component 104 can perform translation of the query from a first form to a second form executable by the database front-end housing system.

The querying system 200 and 202 can be employed for any suitable key-value store 106. In general, the query processor component 104 can execute the representation on the key-value store 106 regardless of a data connection there between. For instance, the key-value store 106 can be cloud-based, server-based, wireless, hard-wired, and the like. In other words, the query processor component 104 can directly execute the representation on the key-value store 106 independent of a physical location (e.g., remote, local, any combination thereof, etc.) and/or data connection (e.g., cloud, wireless, local area network (LAN), any combination thereof, etc.).

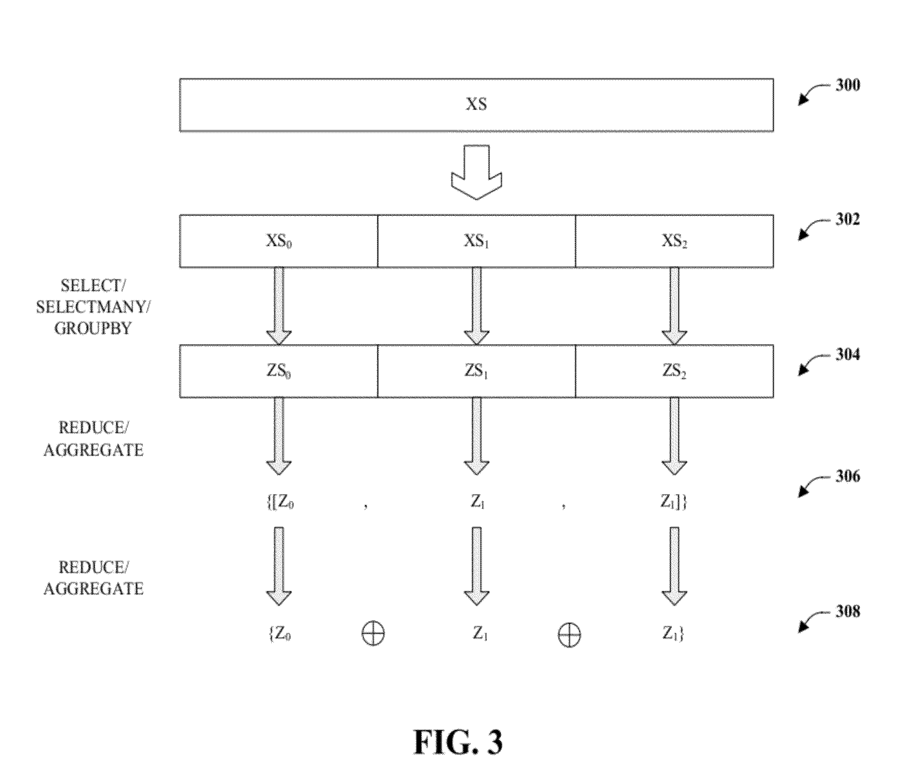

FIG. 3 illustrates an exemplary collection 300 of a key-value store. In general, a LINQ query can be targeted to a collection 300 within a key-value store. As discussed, a representation of the LINQ query is generated based upon a homomorphism characteristic to allow the LINQ query to be executed on the key-value store. Typically, key-value stores are “sharded,” or, in other words, split or partitioned, across multiple computers or machines. If a query is homomorphic, Bird's homomorphism lemma can be exploited to facilitate efficient execution of the query utilizing parallel processing.

The following is high-level discussion of an exemplary transformation of a LINQ query to a representation based upon a homomorphism characteristic that can be carried out by the conversion component 102 of FIG. 1. Here, the LINQ query targets (e.g., to be performed upon) a collection 300 stored within a key-value store. The collection 300 is depicted with “XS,” representing a number of “X”s. The LINQ query targeted for the collection 300 can be transformed into a representation in order to be executed with respect to the key-value store.

The collection 300 is fragmented into at least two sub-collections. A group of sub-collections 302 illustrates a first sub-collection XS₀, a second sub-collection XS₁, and a third collection XS₂. A first LINQ operator can be performed on each of the sub-collections to create a result 304 that includes a first collection ZS₀, a second collection ZS₁, and a third collection ZS₂. For instance, the first LINQ operator can be, but is not limited to, a “Select,” a “SelectMany” or a “GroupBy.” It is to be appreciated that the “SelectMany” operator can be a generalization of the relation “CrossApply” operator.

A second LINQ operator can be performed on the result 304 to create a result 306 that includes a first collection Z₀, a second collection Z₁, and a third collection Z₂ {[Z₀, Z₁, Z₂]} For instance, the second LINQ operator can be at least one of a “Reduce,” or an “Aggregate.” The second LINQ operator can be performed on the result 306 to create a result 308 to the LINQ query that includes {Z₀⊕Z₁⊕Z₂}. It is to be appreciated that the first LINQ operator and the second LINQ operator can be performed in parallel based upon the fragmenting into sub-collections. In other words, the LINQ query can be executed in parallel based upon the generated representation.

Furthermore, it is to be appreciated that the first LINQ operator performed and the subsequent second LINQ operator(s) performed can replicate a map-reduce functionality. The map portion segments an input from a master node across various worker nodes in order to allow the worker nodes to individually process the sub-portions. Subsequently, individual results of the worker nodes can be combined, or reduced, and passed back to the master node as the result. Such efficient parallel process is significant with respect to NoSQL stores, house vast quantities of data across multiple stores or machines.

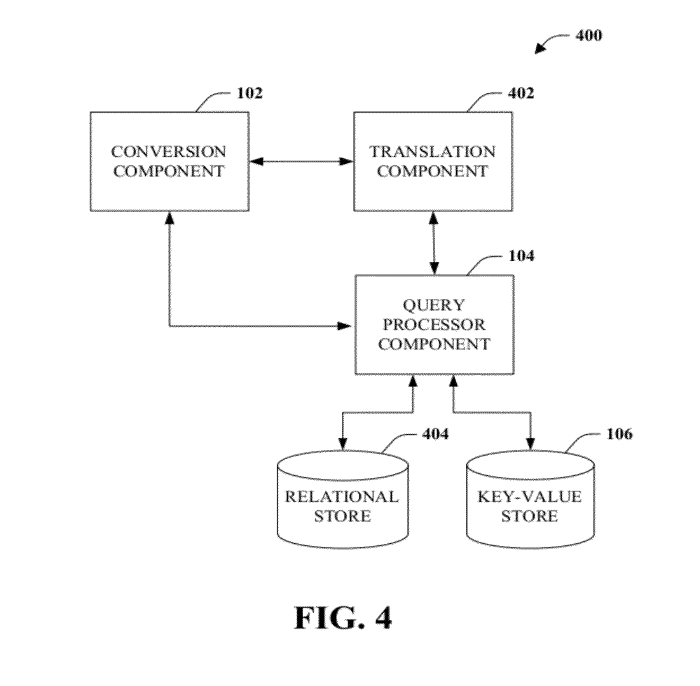

FIG. 4 illustrates a database querying system 400 for relational stores and key-value stores. The database querying system 400 can include the conversion component 102 that converts a LINQ query into a representation based upon a homomorphism characteristic, and in particular, Bird's Homomorphism Lemma, comprising primitive query operators capture map-reduce functionality. The query processor component 104 can be configured to utilize the representation to execute the LINQ query on non-relational, the key-value store 106, or a relational store 404.

The database querying system 400 further includes a translation component 402 that can translate the representation of the LINQ query generated based upon the homomorphism characteristic into a second representation. The second representation is a command or instruction that is acceptable to any suitable to a particular store or managing entity. In other words, the translation component 402 can configure the first representation (e.g., the representation of the LINQ query based upon a homomorphism characteristic) into a second representation that is utilized to execute the query. By way of example and not limitation, the translation component 402 can be configured to generate Transact-SQL (T-SQL) from a first representation to facilitate execution with respect to the relational store 404. Similar translations can also be made to facilitate interactions with particular interfaces with the key-value store 106.

FIG. 5 illustrates a system 500 that facilitates generating a representation of a language-integrated query (LINQ) query. The conversion component 102 generates a representation of a LINQ query based upon a homomorphism characteristic thereof. The representation of the LINQ query is utilized by the query processor component 104 to execute such query on the key-value store 106. The conversion component 102 can further include an algorithm component 502 that facilitates converting the LINQ query into a representation that is utilized to perform the query on the key-value store 106. By way of example and not limitation, the algorithm component 502 is depicted within the conversion component 102. However, it is to be appreciated that the algorithm component 502 can be a stand-alone component, incorporated into the conversion component 102 (as depicted), incorporated into the query processor component 104, incorporated into the key-value store 106, and/or any combination thereof.

The algorithm component 502 can employ algorithms, functions, and operators in order to generate a representation of the LINQ query that is utilized to execute such query on the key-value store 106. By way of example and not limitation, the algorithm component 502 can leverage LINQ operators such as a “Select,” a “SelectMany,” a “GroupBy,” a “Reduce,” and an “Aggregate.” Additionally, the algorithm component 502 creates the representation of the LINQ query based upon a homomorphism characteristic and/or Bird's Homomorphism Lemma.

The following is high-level discussion of an exemplary generation of a representation of a LINQ query that can be carried out by the conversion component 102 and/or the algorithm component 502.

The claimed subject matter exploits the fact that both NoSQL (as well as coSQL) and SQL stores are monads, and that queries can be defined as homomorphisms over monads. In other words, Bird's Homomorphism Lemma can be generalized to homomorphisms over monads. Additionally, Bird's Homomorphism Lemma can be generalized to employ “GroupBy” and “Aggregate” query operators on a store. Accordingly, any homomorphic query can be factored into a “GroupBy” and an “Aggregate” (e.g., LINQ operators), and can be executed in parallel including distributed parallel execution. This especially significant with respect to NoSQL, because vast amounts of data are typically split across multiple machines.

LINQ is a generalization of the relational algebra where instead using sets of rows, monads are used. Just like SQL is expanded from regular syntax into relational algebra expressions, LINQ or monad comprehensions are de-sugared by the compiler into algebraic expressions over primitive query operators. Stated differently, simple programmer-friendly syntax is transformed into complicated less-user-friendly math.

The generalization of the relational algebra operators is as follows where “M” is an abstract notion of collection (instead of “set” in SQL) and “T” represents generic collection elements (e.g., key-value pairs).

| | |
|---|---|
| Ø :: M<T> | (Empty Collection) |
| ∪ :: M<T>xM<T> → M<T> | (Combination of Collections) |
| {_} :: T → M<T> | (Injecting a Value into a Collection) |
| σ_{P} :: M<T>x(T→bool) → M<T> | (e.g., Where operator) |
| π_{F} :: M<T>x(T→S) → M<S> | (e.g., Select operator) |
| X :: M<T>xM<S> → M<TxS> | (e.g., Cross Product operator) |

So-called correlated subqueries are implemented using the “SelectMany” or “Bind” operator:

SelectMany::M<A>x (A→M<B>)→M<B>

Using this operator and “{_},” the rest can be defined as follows:

```
σ_{P}(as) =
  as.SelectMany(λa →
  P(a)?{a}: Ø)
π_{F}(as) =
  as.SelectMany(λa→{F(a)})
as X bs =
  as.SelectMany(λa→
  σ_{λb} _{_{→}} _{(a,b)}(bs))
```

Also provided is an intensional representation of functions, written as “A→B” or as “Expr<A→B>” as follows:

SelectMany::M<A>x (A→M<B>)→M<B>

In many cases, a “map” function can be utilized with the following signature (plus a corresponding one that takes an intensional representation of the function):

Select::M<A>x (A→B)→M<B>

Further, instead of “SelectMany,” a flatten function can be utilized with the following signature:

Join::M<M<A>>→M<A>

It is to be appreciated that the above is not natural in the relational context where nesting is not allowed.

Certain functions of type “h::M<A>→B,” or queries, can be also be factored into simpler functions by recursive decomposition of the argument to the function, as follows:

h({a,b,c})=h({a}∪{b}∪{c})={f(a)}⊕{f(b)}⊕{f(c)}

That is any homomorphism on collection “M<A>” can be defined as:

H as =as.Select(f).Reduce(⊕)

Where “Select” is as above and “Reduce” is defined as follows:

Reduce ({a}∪{b}∪{c})=a⊕b⊕c

For example, “SelectMany(as,f)=as.Select(f).Join( )” and “Join” can be defined as:

Join as =Reduce(∪)

In other words, all homomorphic queries of type “M<A>→B” can be converted in the form “h(as)=as.Select(f).Reduce(⊕)” for some function “f::A→B” and operation “⊕::BxB→B.” Further algebraic properties of “∪” or combinations can be exploited to break collections into various fragments in different ways, such as assuming “∪” is associative as follows:

{a,b,c,d}=({a}∪{b})∪({c}∪{d})

Now, a homomorphic query “h({a,b,c,d})” can be evaluated in parallel in the following way:

(f(a)⊕f(b))⊕(f(c)⊕f(d))

The key-value model associated with NoSQL and coSQL provides a natural partitioning of a collection “M<A>” into sub-collection, based on their key, also, the map function can be generalized to return a collection itself For instance, the key-value store “{K:a, L:b,}” can be split into a nested store as follows:

{{P:w,Q:x},{P:y,Q:z}}

Next, the key-value pairs can be grouped or joined into a single key-value store “{P:{w,y}, Q:{x,z}},” and reduced to “{w⊕y, x|z}.”

Stated more simply, Birds Homomorphism Lemma can be generalized to show that any homomorphic query over a key-value store can be written as a “Select” or a “SelectMany” followed by a “Reduce,” or equivalently by a “GroupBy” followed by an “Aggregate.”

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the conversion component 102 or one or more sub-components thereof can employ such mechanisms to efficiently determine or otherwise infer conversion techniques related to generating a representation of a LINQ query based upon a homomorphism characteristic.

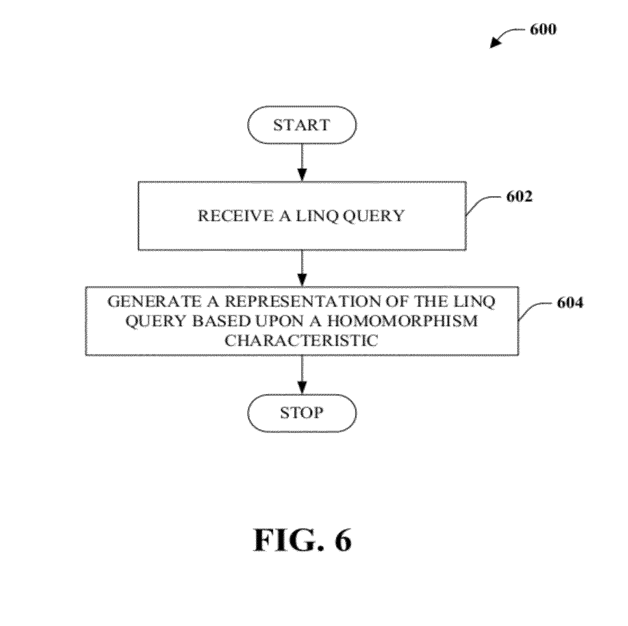

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, a method of transforming a LINQ query into a representation 600 is illustrated. At reference numeral 602, a LINQ query is received. It is to be appreciated that the LINQ query can be aggregated, received, collected, and the like. Moreover, the LINQ query can be targeted to a collection of data stored within a key-value store. At reference numeral 604, a representation of the LINQ query is generated based upon a homomorphism characteristic of the query. By way of example and not limitation, the representation can transform the LINQ query with a first LINQ operator followed by a second LINQ operator. It is to be appreciated that the first LINQ operator can be, but is not limited to, a “Select,” a “SelectMany,” or a “GroupBy.” Additionally, it is to be appreciated that the second LINQ operator can be, but is not limited to, a “Reduce,” or an “Aggregate.” By generating the representation of the LINQ query, a key-value store can execute the query. For instance, a LINQ query can be injected with a first LINQ query operator that can be at least one of a “Select” or a “SelectMany.” The result of the first operator can be further injected with a second LINQ query operator that can be a “Reduce” to generate the representation of the LINQ query. In another example, a LINQ query can be injected with a first LINQ query operator that can be a “GroupBy.” The result of the first operator can be further injected with a second LINQ query operator that can be an “Aggregate” to generate the representation of the LINQ query.

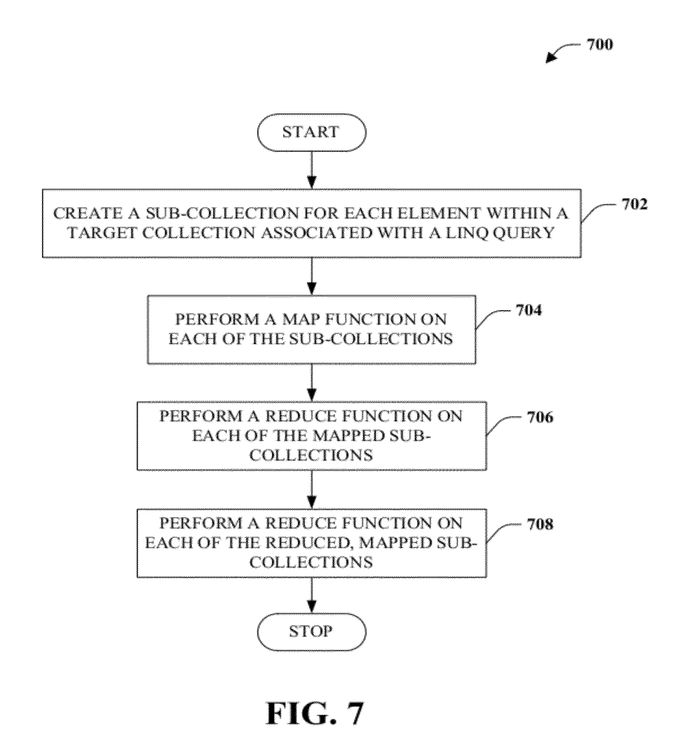

FIG. 7, a method of creating a representation of a LINQ query 700 is illustrated. At reference numeral 702, a sub-collection is created for each element within a target collection associated with a LINQ query. At reference numeral 704, a map function is performed on each of the sub-collections. At reference numeral 706, a reduce function is performed on each of the mapped sub-collections. At reference numeral 708, a reduce function is performed on each of the reduced, mapped sub-collections.

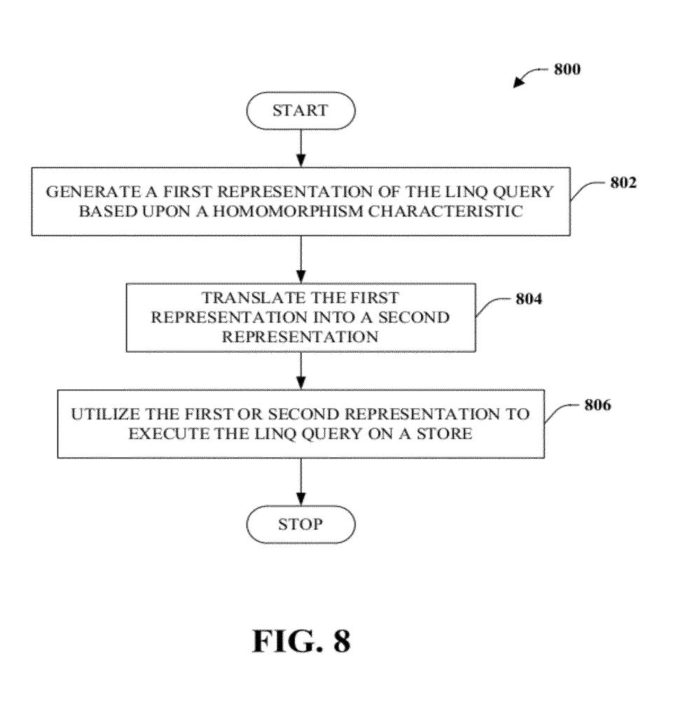

FIG. 8 is a flow chart diagram of a method of querying a relational store and a key-value store with a LINQ query 800. At reference numeral 802, a first representation of the LINQ query is generated based upon a homomorphism characteristic. For example, the first representation can specify parallel execution of the query. At reference numeral 804, the first representation is translated into a second representation, where needed to interact with a particular store. At reference numeral 806, the first representation is utilized to execute the LINQ query on a store, such as a key-value store (e.g., NoSQL, coSQL).

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

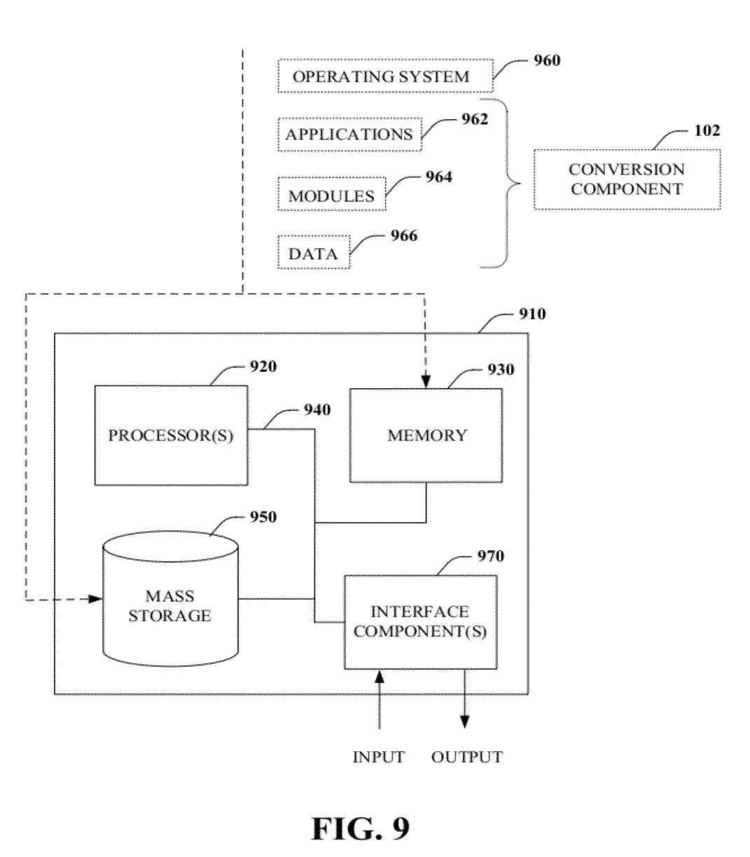

In order to provide a context for the claimed subject matter, FIG. 9 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, server, hand-held, programmable consumer or industrial electronics, set-top box, game system . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 910.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the conversion component 102 can be, or form part, of an application 962, and include one or more modules 964 and data 966 stored in memory and/or mass storage 950 whose functionality can be realized when executed by one or more processor(s) 920, as shown.

In accordance with one particular embodiment, the processor(s) 920 can correspond to a system-on-a-chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the conversion component 102, and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910 through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating database querying, comprising:
employing at least one processor configured to execute computer-executable instructions stored in memory to perform the following acts:
generating a representation of a language-integrated query based upon a homomorphism characteristic of the query.

2. The method of claim 1, further comprising executing the query on a key-value store utilizing the representation.

3. The method of claim 1, generating the representation further comprises:
injecting a first language-integrated query operator with respect to the query; and
injecting a second language-integrated query operator on a result of the first operator.

4. The method of claim 3, injecting at least one of a “Select” operator or a “SelectMany” operator as the first language-integrated query operator.

5. The method of claim 3, injecting at least one of a “Reduce” operator as the second language-integrated query operator.

6. The method of claim 3, injecting a “GroupBy” operator as the first language-integrated query operator.

7. The method of claim 3, injecting an “Aggregate” operator as the second language-integrated query operator.

8. A system that facilitates database querying, comprising:
a processor coupled to a memory, the processor configured to execute the following computer-executable components stored in the memory:
a conversion component configured to generate a representation of a language-integrated query that enables parallel execution based upon a homomorphism characteristic of the query.

9. The system of claim 8, the conversion component is configured to generate the representation with a first language-integrated query operator that partitions data.

10. The system of claim 9, the first language-integrated query operator is at least one of a “Select” operator or a “SelectMany” operator.

11. The system of claim 9, the second language-integrated query operator is a “Reduce” operator.

12. The system of claim 9, the first language-integrated query operator is a “GroupBy” operator.

13. The system of claim 9, the conversion component is configured to generate the representation with a second language-integrated query operator that combines results over two or partitions.

14. The system of claim 13, the second language-integrated query operator is an “Aggregate” operator.

15. The system of claim 8, further comprising a query processor component configured to execute the query on a key-value store utilizing the representation.

16. The system of claim 15, the query processor component is located within a database system associated with the key-value store.

17. The system of claim 15, the query processor component communicates a result of the query to a source providing the query.

18. The system of claim 8, further comprising a query processor component configured to execute the query on a relational store utilizing the representation.

19. A method of database querying, comprising:
employing at least one processor configured to execute computer-executable instructions stored in memory to perform the following acts:
evaluating a language-integrated query to identify a targeted collection;
creating two or more sub-collections for elements within the targeted collection;
performing a map function on the sub-collections associated with the target collection;
performing a reduce function on mapped sub-collections; and
performing a reduce function on reduced, mapped sub-collections.

20. The method of claim 19, evaluating the query to identify a targeted collection of key-value pairs.
